(19) United States
(12) Patent Application Publication
(10) Pub. No.: US 2004/0036406 A1
(43) Pub. Date: Feb. 26, 2004

(54) UV fluorescent tube for tanning the skin by means of UV radiation

(76) Inventor: Frank Richarz, Bonn (DE)

Correspondence Address: Martin G. Linihan, Hodgson Russ LLP, One M&T Plaza, Suite 2000, Buffalo, NY, 14203-2391, US

(21) Appl. No.: 10/418,377

(22) Filed: Apr. 18, 2003

(30) Foreign Application Priority Data
Apr. 23, 2002 (DE) 10218114.4

(51) Int. Cl. H01J 1/62; H01J 63/04

(52) U.S. Cl. 313/485

(57) ABSTRACT

The invention relates to a UV fluorescent tube for tanning the skin by means of UV radiation having a discharge vessel for an electrical discharge of gas; having a discharge medium received in the discharge vessel wherein a primary radiation may be generated by means of a discharge of gas; and having a transforming agent for transforming the primary radiation into an emissible UV radiation useable for tanning. The UV fluorescent tube in accordance with the invention is characterized in that said transforming agent is selected such that there occurs a maximum spectral intensity of said emissible UV radiation at a wavelength which is larger than a wavelength at which the maximum pigment darkening of the skin occurs; and that the spectral intensity of said emissible radiation at the wavelength where the maximum pigment darkening of the skin occurs, is smaller than 50% of the maximum spectral intensity.

The present invention relates to a UV fluorescent tube for tanning the skin by means of ultraviolet light radiation in accordance with the preamble of claim 1.

UV fluorescent tubes or lamps of such a type are known and have a discharge vessel for an electrical discharge of gas, a discharge medium received in said discharge vessel wherein a primary radiation may be generated by means of an electrical discharge of gas, and a transformation agent for transforming the primary radiation into UV radiation which may be emitted and used for tanning the skin.

In low-pressure fluorescent tubes, the primary radiation resulting from the spectrum of mercury is usually transformed into visible light and UV radiation useable for tanning the skin in so-called phosphors. As the phosphors, a variation of silicates, borates, aluminates containing various dopes selected from lead, europium and cerium are employed.

Depending upon the phosphors used, there are generated distinct emission spectra having characteristic maximum emission peaks and half-value widths. The type of phosphors primarily used is a BaSiO₅:Pb²⁺ compound having a maximum peak of emission at about 350 nm and a half-value width of 40 to 50 nm. This phosphor is, hence, emitting light primarily in the UV-A region and thus substantially contributes to darkening the pigments in the skin. However, due to its large half-value width, this phosphor has considerable portions of short wavelength light which, when an evaluation of the risk of erythemas is made, have a negative impact, since the risk of receiving a sunburn is increased by said short wavelength light.

For generating UV light suitable for the pigment generation, there are mainly used aluminates having a dope of Ce³⁺. The maximum peak of emission of such substances is found at about 300 to 303 nm, and they have a half-value width of about 20 to 30 nm.

Moreover, LaPO₄:Ce³⁺ is in use for the generation of dark pigments; said substance has a maximum peak of emission at 314 nm and a half-value width of 18 nm.

Tanning of the skin primarily occurs by generating pigments therein and darkening said pigments. The corresponding efficiency functions are described in German Industrial Standard (DIN) 5031.

The efficiency function for the pigment generation has a maximum peak at about 300 nm and, with respect to its course, is very similar to the erythema efficiency function. The efficiency function for darkening pigments has a maximum peak at about 340 nm and has a distribution between 300 and 400 nm.

Due to the very similar course of the efficiency functions for the pigment generation and for the erythema development, those effects of the UV radiation actually cannot be separated from each other.

Commercially available UV fluorescent tubes comprise lead-doped barium silicate as the primary component. While, by using said compound, good intensities and pigment darkening properties may be obtained, there is still a non-insignificant risk of erythemas and, respectively, sunburn being generated due to the comparatively large short wavelength portions of the radiation emission spectrum.

Hence, it was an object of the present invention to provide a UV fluorescent tube of the above-mentioned type where superior pigment darkening properties are prevailing and the risk of a sunburn is substantially reduced.

This object is achieved by the UV fluorescent tube having the features of claim 1.

Advantageous embodiments of the UV fluorescent tube according to the invention are claimed in the subclaims.

According to the invention, a UV fluorescent tube of the above-referenced type is further embodied by the fact that the transforming agent is selected such that the maximum spectral intensity of the emissible UV radiation occurs at a wavelength longer than a wavelength at which the maximum pigment darkening of the skin occurs, and that the spectral intensity of the emissible radiation at a wavelength at which the maximum pigment darkening occurs is smaller than 50% of the maximum spectral intensity.

The invention is based on the finding that a transforming agent which is intended to contribute primarily to a darkening of the skin pigments is not necessarily given a high erythema evaluation.

It may be considered to be a core concept of the solution according to the invention that the transforming agent is selected in such a way that, on the one hand, the emission of UV radiation substantially occurs at wavelengths larger than a wavelength at which the maximum pigment darkening of the skin occurs, and that, on the other hand, such a UV radiation emission is effected at a sufficiently narrow band so that the spectral intensity at the wavelength at which the maximum pigment darkening occurs, has already dropped to less than 50% of the maximum spectral intensity.

It may be considered to be a substantial advantage of the UV fluorescent tube according to the invention that excellent pigment darkening properties are obtained, without that this is correlated to an increase of the risk to receive a sunburn.

In a preferred embodiment of the UV fluorescent tube according to the invention, the spectral intensity of the emissible UV radiation at a wavelength at which the maximum pigment darkening occurs, is smaller than 10% of the maximum spectral intensity, preferably smaller than 5% of the maximum spectral intensity. By establishing such values, the risk to receive a sunburn may be reduced even further.

The transforming agent may particularly be in the form of a two-phosphor system including a first phosphor agent and a second phosphor agent. Preferably, the second phosphor agent substantially exclusively contributes to a darkening of the pigment(s).

Particularly good results with respect to a darkening of the pigment(s) and a generation of pigment(s) without a sunburn risk were achieved in cases where the first phosphor agent has a maximum peak of emission at about 300 nm and a half-value width of about 30 nm and where the second phosphor agent has a maximum peak of emission of about 370 nm and a half-value width of about 20 nm. The first phosphor agent effects the generation of pigments, and the second phosphor agent substantially exclusively contributes to a darkening of the pigment(s) and does not provide any contribution to erythema generation. In such a system, the pigment darkening may be increased by up to 20%, without an increase of the erythema value.

As the second phosphor agent, there may be used, for example, SrB₄O₇:Eu²⁺ having a maximum peak of emission at about 368 to 370 nm and a half-value width of below 20 nm.

In order to achieve a sufficient pigment generation, the transforming agent is suitably selected in such a way that a second maximum value of the spectral intensity of the emissible UV radiation occurs at a wavelength where pigments are generated to a maximum extent.

For this purpose, cerium-doped aluminum compounds may be used preferably as the first phosphor agent. For example, SrAl₁₂O₁₉:Ce³⁺ having an emission maximum value at about 302 nm and a half-value width of about 27 nm may be employed as the first phosphor agent.

Further characteristic properties of the UV fluorescent tube according to the invention are in detail explained below with reference to the enclosed figures, wherein:

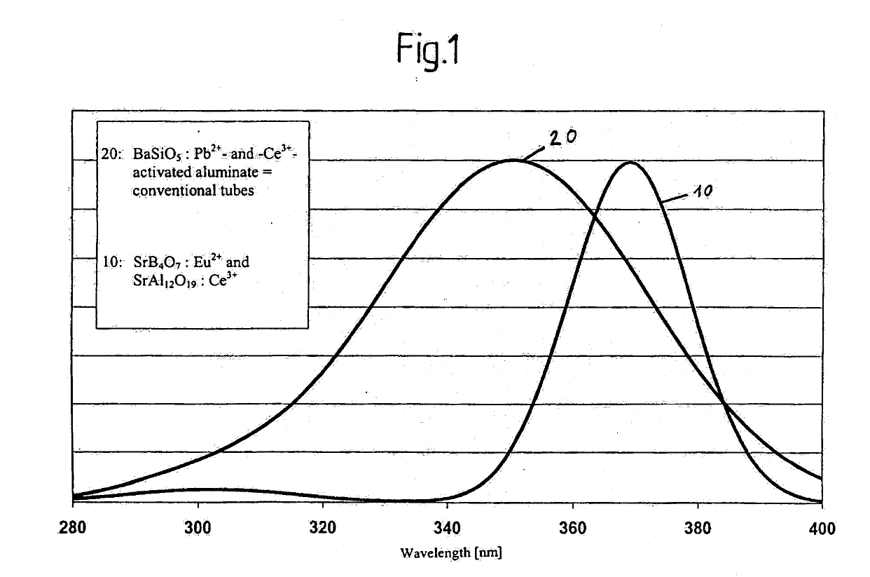

FIG. 1 shows the emission spectrum of a UV fluorescent tube according to the invention in comparison to the emission spectrum of a conventional UV fluorescent tube; and

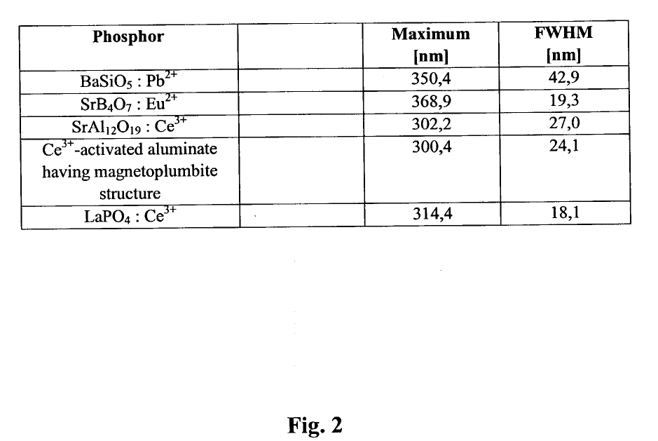

FIG. 2 shows a Table exhibiting relevant emission data of phosphor agents.

FIG. 1 shows the emission spectrum 10 of a UV fluorescent tube according to the invention and an emission spectrum 20 of a conventional UV fluorescent tube. The emission spectra 10 and 20 are scaled in such a way that their maximum values correspond to each other. Actually, the emission spectra 10 and 20 have the same intensity at about 300 nm.

The emission spectrum 10 is the spectrum of a tube having a two-phosphor system comprising SrB₄O₇:Eu²⁺ and SrAl₁₂O₁₉:Ce³⁺ as the transforming agent.

The emission spectrum 10 has a main maximum value at about 370 nm, which value is shifted to longer wavelengths by about 30 nm in comparison to the wavelength of 340 nm where a maximum pigment darkening of the skin occurs. At a wavelength of 340 nm where a maximum pigment darkening of the skin occurs, the spectral intensity curve 10 is dropped to less than 3% of the maximum spectral intensity. The emission spectrum 10 has a second emission maximum value at 300 nm, which emission maximum value is due to the emission of SrAl₁₂O₁₉:Ce³⁺. The spectral intensity at this maximum value, however, is only about 4% of the maximum spectral intensity at 370 nm.

The substantially fundamental feature distinguishing the emission spectrum 10 of the UV fluorescent tube according to the invention from the emission spectrum 20 of a conventional tube is the maximum emission value at about 350 nm. However, the latter, in comparison to the maximum emission value of the spectrum 10, has a considerably larger half width value of about 50 nm. Another maximum value is found at about 300 nm, which value, however, is only relatively weakly developed, so that it cannot be recognized under the selected scale.

At a wavelength of 300 nm where a maximum generation of pigments is observed, the actual spectral intensities of the emission spectra 10 and 20 correspond to each other, on the one hand. On the other hand, the risk of sunburns from the UV fluorescent tubes in accordance with the present invention is considerably reduced, compared to conventional fluorescent tubes, which reduction is due to the clearly decreased spectral intensity in the range around 320 nm.

The Table in FIG. 2 summarizes the data of several phosphors relevant for the UV emission. In the Table, “FWHM” (Full Width Half Maximum) means the half value width.

1. A UV fluorescent tube for tanning the skin by means of UV radiation
having a discharge vessel for an electrical discharge of gas;
having a discharge medium received in the discharge vessel wherein a primary radiation may be generated by means of a discharge of gas; and
having a transforming agent for transforming the primary radiation into an emissible UV radiation useable for tanning;
characterized in that
said transforming agent is selected such that there occurs a maximum spectral intensity of said emissible UV radiation at a wavelength which is longer than a wavelength at which the maximum pigment darkening of the skin occurs; and that
the spectral intensity of said emissible radiation at the wavelength where the maximum pigment darkening of the skin occurs, is smaller than 50% of the maximum spectral intensity.

2. The UV fluorescent tube according to claim 1, characterized in that the spectral intensity of said omissible UV radiation at the wavelength where maximum pigment darkening occurs, is smaller than 10%, preferably smaller than 5% of the maximum spectral intensity.

3. The UV fluorescent tube according to any of claims 1 or 2, characterized in that said transforming agent is in the form of a two-phosphor-system comprising a first phosphor agent and a second phosphor agent.

4. The UV fluorescent tube according to claim 3, characterized in that the second phosphor agent substantially exclusively contributes to a pigment darkening.

5. The UV fluorescent tube according to any of claims 3 or 4, characterized in that the first phosphor agent has an emission maximum value at about 300 nm and a half value width of about 30 nm, and that the second phosphor agent has an emission maximum value at about 370 nm and a half value width of about 20 nm.

6. The UV fluorescent tube according to any of claims 3 to 5, characterized in that the first phosphor agent is a cerium-doped aluminum compound, in particular is SrAl₁₂O₁₉:Ce³⁺.

7. The UV fluorescent tube according to any of claims 3 to 6, characterized in that the second phosphor agent is SrB₄O₇:Eu²⁺.

8. The UV fluorescent tube according to any of claims 1 to 7, characterized in that the transforming agent is selected such that a second maximum value of the spectral intensity of said emissible UV radiation occurs at a wavelength where the maximum pigment generation occurs.
